(19) United States
(12) Patent Application Publication
(10) Pub. No.: US 2020/0022332 A1
(43) Pub. Date: Jan. 23, 2020

(54) Dog And Cat Table Feeder

(71) Applicant: Delia I Gill, (US)

(72) Inventors: Ruben D. Nessy, Miami, FL (US); Delia I. Gill, Miami, FL (US)

(73) Assignee: Delia I Gill, Miami, FL (US)

(21) Appl. No.: 16/275,268

(22) Filed: Feb. 13, 2019

(51) Int. Cl. A01K 5/01

(52) U.S. Cl. CPC A01K 5/0114; A01K 7/00

(57) ABSTRACT

The following invention with a variety of models and sizes relates to a table intended specifically for animals, where an owner of one or more pets can feed and provide water for all at the same time.

In most cases, the conventional food bowls must be placed within distance from one another when feeding all the pets to avoid confrontation or to avoid them eating each other's food. Also, pets often tilt the bowl after being served water or food and this becomes a repeated issue. Not to mention the tedious searching and gathering each bowl, as well as the food and measuring cup. To avoid this, two of the models of the invention provide storage space to keep everything in one place. Also, each of the models have an exact space wide for the bowl, therefore the pets can't grab the bowls after eating and misplace them throughout the household, it is only reachable for the owner to grab and place it back. The table feeder is easy to put away, more than one pet can be fed at the same time, water and food can be placed next to each other, the table feeder is not heavy and looks organized and can be made in other colors that suit best the design and decoration.

### TECHNICAL FIELD

The present invention relates to an appropriate size table used to feed more than one pet at a time, ideal for pets such as cats and dogs.

### BACKGROUND ART

The traditional way of feeding and providing water for pets is a simple bowl placed on the floor, a bowl that can be tilted over easily, grabbed and be misplaced by the same pets. This feeding method often creates conflicts and fights between the pets in the household as it doesn't give them privacy while eating. The Dog and Cat Table Feeder provides a simple and sophisticated way of feeding all your pets at the same time and in the same room.

### SUMMARY OF INVENTION

The table feeder invention allows pet owners to save time and space when feeding all the pets in the household.

VERSION 1 SIZE B and C, as well as VERSION 2 size B and C of the table feeder allows pet owners who have more than one pet in the household to feed them simultaneously as it has space for four bowls. However, if less than four pets are to be fed, the other bowls can be used for water. This not only saves space but it avoids confrontation between the pets while eating as animals can be protective over their food.

The VERSION 3 SIZE B and C of the pet feeder is ideal and useful if only one or two pets will be fed. As the design has space for two bowls which can be used for food and/or water. This design also has a storage compartment for the food, reachable only to the owner. It accommodates small spaces, and everything is maintained in a single place, when feeding the pets, the owner does not have to search for the food, the bowls, portion scoop, etc. rather everything is organized in one space.

Also, the pet feeder is easy to carry and move around as it is less than approximately 7 lbs heavy depending on the size model. It can be made in any desired color to accommodate the design of the room where it will be placed. And the table is reachable for cats and dogs of any size.

### BRIEF DESCRIPTION OF THE DRAWINGS

FIG. 1-2 VERSION 1 SIZE B is a lateral view of the design with four bowls, it also shows a separate visual with the dimensions tall and a drawing of the dimensions showing the top view.

FIG. 2-2 VERSION 1 SIZE B shows the design disassembled and the specs of the screws.

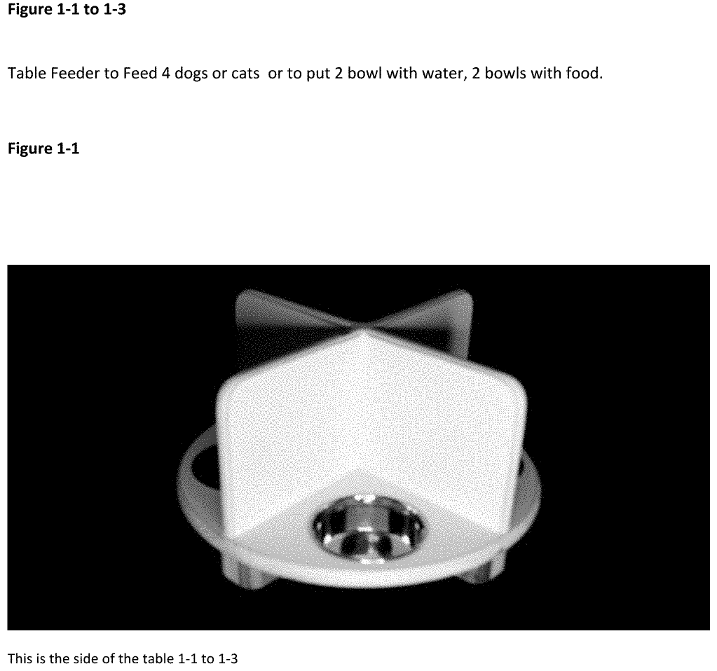

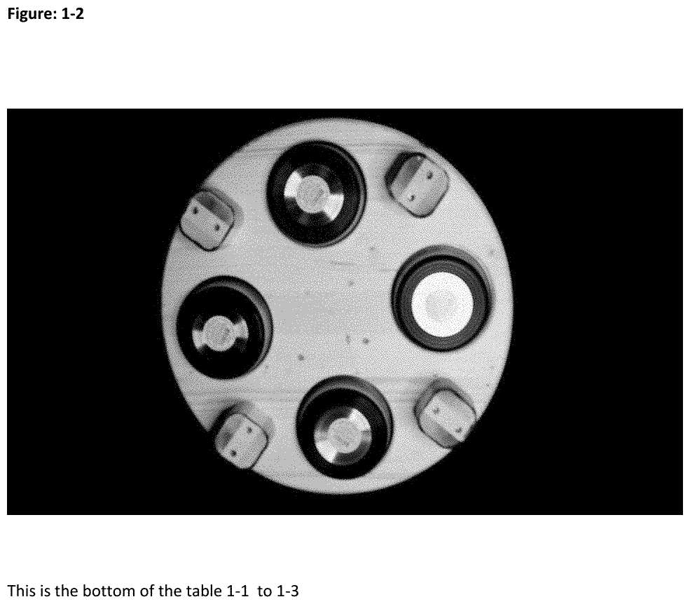

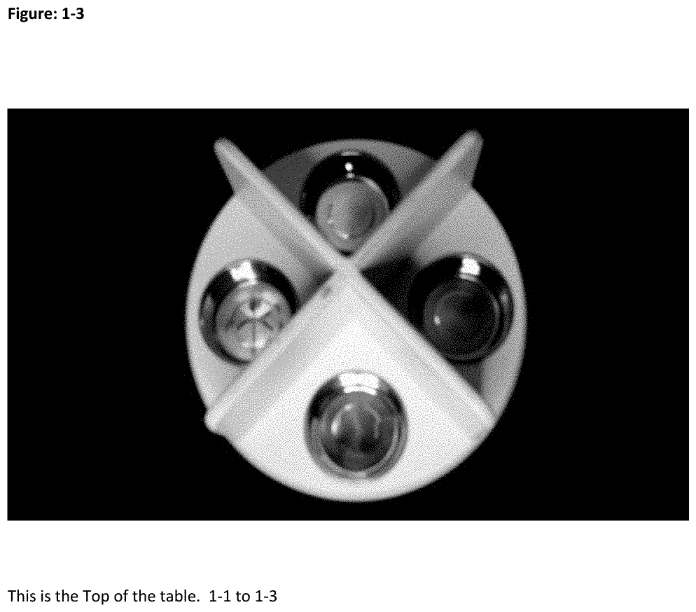

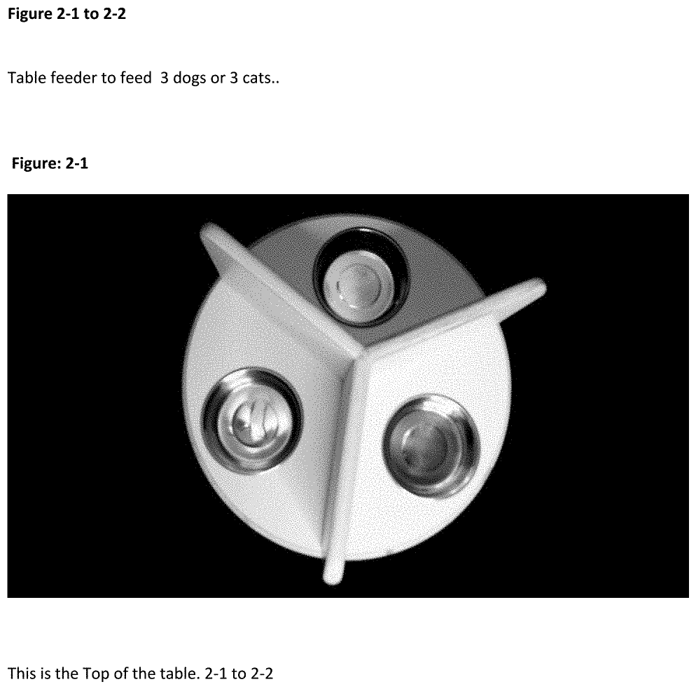

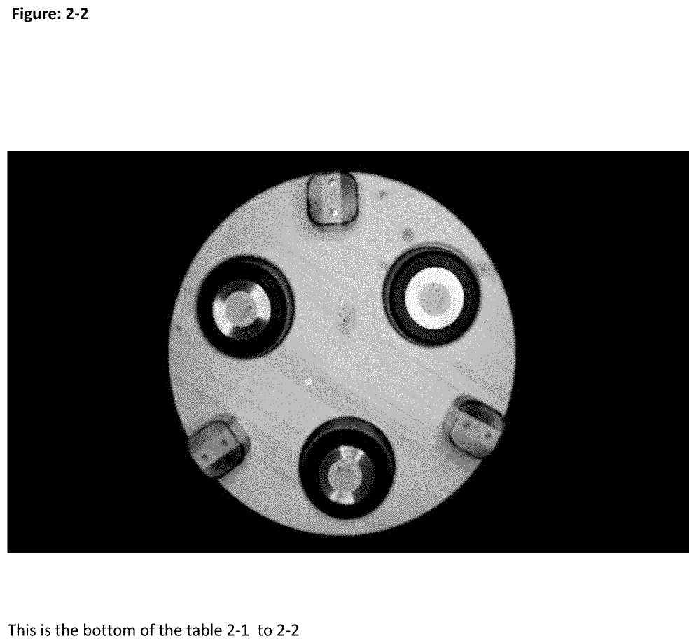

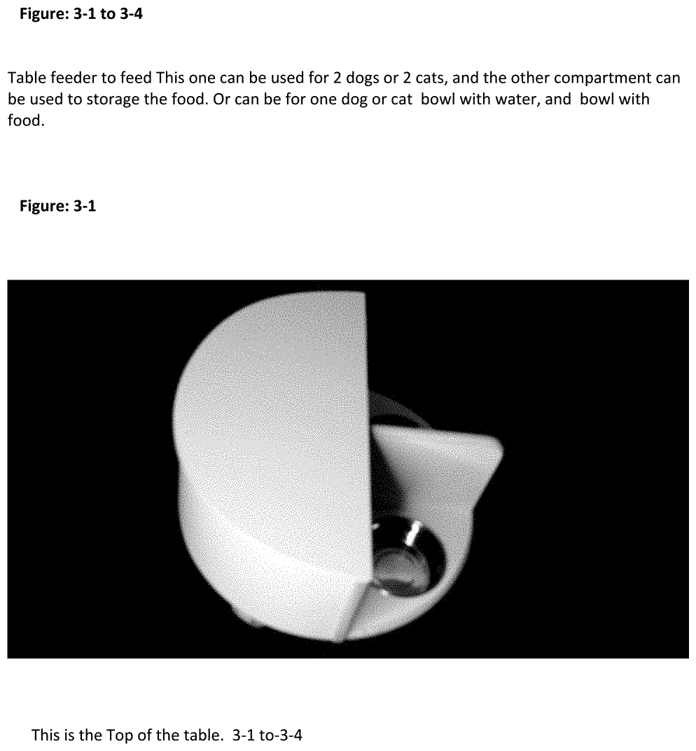

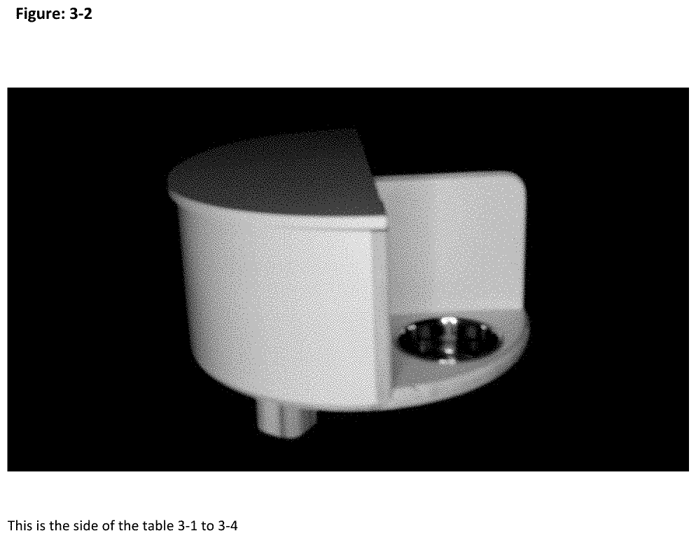

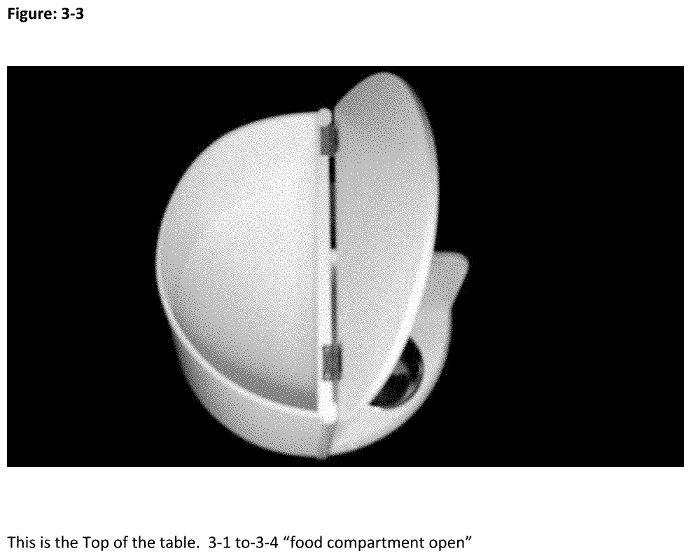

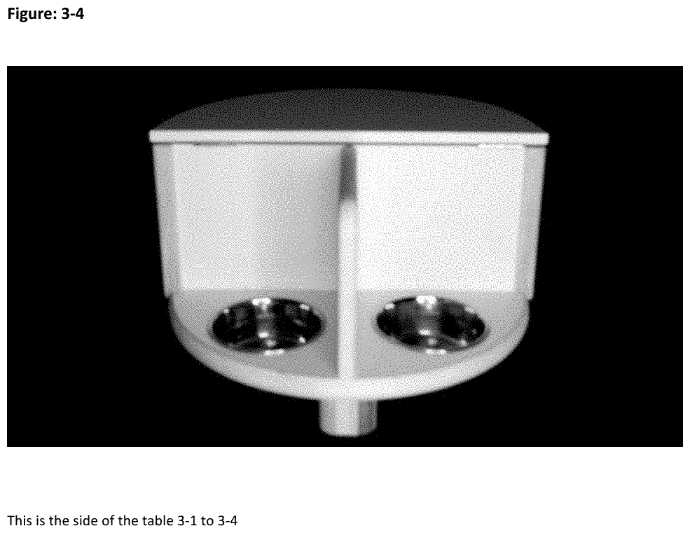

FIG. 1-2 VERSION 2 SIZE B is a lateral perspective of the design with three bowls, it also shows a separate visual with the dimensions tall and a drawing of the dimensions showing the top view.

FIG. 2-2 VERSION 2 SIZE B shows the design disassembled and the specs of the screws.

FIG. 1-2 VERSION 3 SIZE B is a lateral view of the design with two bowls and the storage compartment, it also shows a separate visual with the dimensions tall and a drawing of the dimensions showing the top view.

FIG. 2-2 VERSION 3 SIZE B shows the as it would be assembled and the specs of the screws.

FIG. 1-2 VERSION 1 SIZE C is a lateral view of the design with four bowls, it also shows a separate visual with the dimensions tall and a drawing of the dimensions showing the top view.

FIG. 2-2 VERSION 1 SIZE C shows the design disassembled and the specs of the screws.

FIG. 1-2 VERSION 2 SIZE C is a lateral view of the design with three bowls, it also shows a separate visual with the dimensions tall and a drawing of the dimensions showing the top view.

FIG. 2-2 VERSION 2 SIZE C shows the design disassembled and the specs of the screws.

FIG. 1-2 VERSION 3 SIZE C is a lateral view of the design with two bowls and the storage compartment, it also shows a separate visual with the dimensions tall and a drawing of the dimensions showing the top view.

FIG. 2-2 VERSION 3 SIZE C shows the design as it would be assembled and the specs of the screws.

### DETAILED DESCRIPTION OF PREFERRED EMBODIMENTS

A dog and cat table feeder Version 1 Size B has a base of 18″ in diameter and 1″ wide. The base is supported by four small legs measured 1.95″ tall and 2.50″ wide, each leg is inserted with two 90065A212 flat head Philips screws (FIG. 2-2). There are four walls of the same measure, 8″ tall and 8.70″ wide and 1″ thick with rounded top corners. In the base, there are four round equal spaces to position bowls of 5″ in diameter.

Version 2 Size B of the pet feeder has a base of 18″ in diameter and 1″ wide. The base is supported by three small legs measured 1.95″ tall and 2.50″ wide, each leg is inserted with two 90065A212 flat head Philips screws (FIG. 2-2). There are three walls of the same measure; 8″ tall, 8.70″ wide and 1″ thick with rounded top corners. In the base, there are four round equal spaces to position bowls of 5″ in diameter.

The pet feeder with storage; Version 3 Size B has a base of 18″ in diameter and 1″ wide. The base is supported by three small legs measured 1.95″ tall and 2.50″ wide, each leg is inserted with two 90065A212 flat head Philips screws (FIG. 2-2). This design has two walls, one goes across the base and is 17.40″ wide and 8″ tall, the smaller wall is 8″ tall, 8.70″ wide and 1″ thick. These two walls are assembled with 90065A205 flat head Philips screw. The storage compartment has a lid that opens outward and is assembled to the top with 90065A110 flat head Philips screws and 1586A230 surface-mount hinge with holes.

Version 1 Size C has a base of 24″ in diameter and 1″ wide. The base is supported by four small legs measured 1.95″ tall and 2.50″ wide, each leg is inserted with two 90065A212 flat head Philips screws (FIG. 2-2). There are four walls of the same measure: 10″ tall and 12″ wide and 1″ thick with rounded top corners. In the base, there are four equal round spaces to position bowls of 8″ in diameter.

Version 2 Size C of the pet feeder has a base of 24″ in diameter and 1″ wide. The base is supported by three small legs measured 1.95″ tall and 2.50″ wide, each leg is inserted with two 90065A212 flat head Philips screws (FIG. 2-2). There are three walls of the same measure; 10″ tall, 12″ wide and 1″ thick with rounded top corners. In the base, there are four round equal spaces to position bowls 8″ in diameter.

The pet feeder with storage; Version 3 Size C has a base of 24″ in diameter and 1″ wide. The base is supported by three small legs measured 1.95″ tall and 2.50″ wide, each leg is inserted with two 90065A212 flat head Philips screws (FIG. 2-2). This design has two walls, one goes across the base and is 23.40″ wide and 10″ tall, the smaller wall is 10″ tall, 12″ wide and 1″ thick. These two walls are assembled with 90065A205 flat head Philips screw. The storage compartment has a lid that opens outward and is assembled to the top with 90065A110 flat head Philips screws and 1586A230 surface-mount hinge with holes.

1. A table feeder for pets made of plywood.

2. The table feeder of claim 1, which has a round base made out of plywood with empty deep spaces to place the bowls.

3. The table feeder of claim 2, whereby has separations in the middle of the base by another piece of plywood creating more walls across the base

4. The table feeder of claim 3, wherein has a storage compartment with a lid opening outward also made out of plywood.

5. The table feeder of claim 4, further comprising three to four short legs made out of wood.
